(19) United States
(12) Patent Application Publication
(10) Pub. No.: US 2010/0015421 A1
(43) Pub. Date: Jan. 21, 2010

(54) TONER COMPOSITION FOR PRINTING ON TRANSPARENT AND HIGHLY COLORED SUBSTRATES

(76) Inventors: Dinesh Tyagi, Fairport, NY (US); Louise Granica, Victor, NY (US)

Correspondence Address: EASTMAN KODAK COMPANY;PATENT LEGAL STAFF, 343 STATE STREET, ROCHESTER, NY, 14650-2201, US

(21) Appl. No.: 12/474,285

(22) Filed: May 29, 2009

Related U.S. Application Data
(60) Provisional application No. 61/057,058, filed on May 29, 2008.

(51) Int. Cl. B32B 5/16; G03G 9/08; G03G 9/087; G03G 9/097; G03G 9/107; G03G 13/20; B32B 3/10

(52) U.S. Cl. 428/207; 430/105; 430/108.6; 430/108.7; 430/111.41; 430/124.1; 428/206

(57) ABSTRACT

When color images are printed on a substantially transparent substrate, such as a transparency film, or on a highly colored substrate, the color properties of image may be compromised. When color images are printed on a substantially transparent substrate, the images do not have the maximum possible color saturation because a large portion of the incident light is not reflected back. As a result, images appear to be dull and lower in contrast. When color images are printed on highly colored substrates, the color properties of the image are also influenced by the color of the substrate. In order to enable printing on such substrates, an opaque toner was developed which comprises predispersed inorganic filler with a refractive index of greater than 1.75.

### CROSS-REFERENCE TO RELATED APPLICATIONS

This is a 111A application of Provisional Application Ser. No. 61/057,058, filed May 29, 2008, the disclosure of which is incorporated by reference herein.

### FIELD OF THE INVENTION

This invention relates in general to toner and developer useful for electrographic printing, and more particularly to an opaque toner composition that can be used as a fifth color to allow printing on substantially transparent receivers or highly colored substrates.

### BACKGROUND OF THE INVENTION

One common method for printing images on a receiver member is referred to as electrography (also referred to as electrostatography). In this method, an electrostatic image may be formed on a dielectric member by uniformly charging the dielectric member and then discharging selected areas of the uniform charge to yield an image-wise electrostatic charge pattern. Such discharge is typically accomplished by exposing the uniformly charged dielectric member to actinic radiation provided by selectively activating particular light sources in an LED array or a laser device directed at the dielectric member (this embodiment is typically referred to as electrophotography). Alternatively, the image-wise electrostatic charge pattern may be formed directly on a chargeable member. After the image-wise charge pattern is formed, the pigmented (or in some instances, non-pigmented) marking particles, or toner, are given a charge, substantially opposite the charge pattern on the dielectric member and brought into the vicinity of the dielectric member so as to be attracted to the image-wise charge pattern to develop such pattern into a visible image.

Thereafter, a suitable receiver member (e.g., cut sheet of plain bond paper) is brought into juxtaposition with the marking particle developed image-wise charge pattern on the dielectric member. A suitable electric field is applied to transfer the marking particles to the receiver member in the image-wise pattern to form the desired print image on the receiver member. The receiver member is then removed from its operative association with the dielectric member and subjected to heat and/or pressure to permanently fix the marking particle print image to the receiver member. Plural marking particle images of, for example, different color particles respectively can be overlaid on one receiver member (before fixing) to form a multi-color print image on the receiver member.

These color printed images produced on electrographic devices have found many usages in both commercial and consumer applications. One of the applications that is increasingly becoming more important is the printing on a substantially transparent substrate, such as a transparency film or a highly colored substrate. When color images are printed on a substantially transparent substrate, the images do not have the maximum possible color saturation because a large portion of the incident light is not reflected back. As a result, images appear to be dull and lower in contrast.

A problem also surfaces when it is desired to print a color image or information on a substrate which has a layer of an adhesive that has been applied to one side. In such a situation, it is not possible to print on the adhesive side of the substrate, as it would not fulfill necessary physical requirements of a color print. Also, the adhesive is likely to contaminate the inside of the electrophotographic printer and cause premature failure of components, leading to subsequent loss of operating time.

Further, it is often required that a color image of information be protected from the harsh chemical or physical environment. One example of this application would be when physical abrasion subjected on a color image is too much for toner image to combat. Another example would be when the image is exposed to highly acidic or alkaline conditions that the toner components are not capable of surviving.

This invention describes various embodiments for an opaque toner composition which enables the printing of color images on substantially transparent or highly colored substrates while addressing the various concerns that have been outlined above.

### SUMMARY OF THE INVENTION

A feature of the present invention is to provide an opaque electrophotographic toner, which is capable of providing reflective background to either a substantially transparent or highly colored substrate.

A feature of the present invention is to provide an opaque electrophotographic toner, which is capable of being used in an electrophotographic process which involves more than four color modules.

A further feature of the present invention is to provide an electrophotographic opaque toner formulation that provides sufficiently low melt viscosity so as to be capable of being fused simultaneously with standard color toners.

Another feature of the present invention is to provide an opaque electrophotographic toner, which is capable of providing reflective background to either a substantially transparent or highly colored substrate in a contact roller fusing or fixing method.

Another feature of the present invention is to provide a two component developer which can be used in an electrophotographic printer to provide an opaque overcoat in either a uniform manner or a selective manner depending on the image content and the desired level of protection.

Additional features and advantages of the present invention will be set forth in part in the description which follows, and in part will be apparent from the description, or may be learned by practice of the present invention. To achieve these and other advantages and in accordance with the purposes of the present invention as embodied and broadly described herein, the present invention relates to toner particles or a toner formulation containing at least one toner resin and at least one pre-dispersed additive which imparts opacity to the formulation.

This invention is directed to toner and developer useful for electrographic printing, and more particularly to an opaque toner composition that can be used as a fifth color to allow printing on substantially transparent receivers or highly colored substrates. Such electrographic printing preferably includes the steps of forming a desired print image, electrographically, on a receiver member utilizing cyan, yellow, magenta, and black (CYMK) color marking particles; and in the area of the formed print image, where opacity is desired, selectively forming an opaque toner layer, utilizing an opaque toner of this invention whose composition is different from that of the CYMK marking particles of the desired print image. In the preferred embodiment, the toner of this invention is opaque and does not contain any colored pigment and is used over or under the color image formed with the standard CYMK toners.

It was determined that it is possible to prepare an opaque toner formulation which is essentially opaque and is capable of forming an opaque background to a color image as a fifth color to allow printing on substantially transparent receivers or highly colored substrates. The opaque toner could be applied uniformly or selectively to the aforementioned substrates.

This is achieved by using inorganic fillers, which would increase the opacity of the toner to the extent that it is capable of reflecting 100% of the light that is incident on it. These inorganic fillers are selected such that their refractive index is greater than 1.75. Among the many inorganic fillers that are available, the preferred inorganic filler is titanium dioxide.

One of the problems with these inorganic fillers is their incompatibility with the typical toner binders. This problem becomes even more evident, when toner binders are being considered for high speed digital printers where the melt viscosity of the toner tends to be low to allow adequate fusing of image in a short dwell time. As a consequence, the dispersion of the inorganic fillers tends to be very poor due to the very low shear forces that can be applied during the toner manufacturing processes. A poor dispersion of the inorganic filler does not increase the opacity of the toner very efficiently. In order to make a suitable opaque toner with such poorly dispersed inorganic fillers, a much higher amount of inorganic filler is necessary. This approach suffers from several drawbacks. When such opaque toners are prepared comprising poorly dispersed inorganic fillers, resulting toners have a very high melt viscosity due to the excessive amount of inorganic filler used to prepare such toners. Also, as the inorganic fillers concentration is increased, the charging behavior of the toner is also affected. This affects not only the developer life, but also leads to poor reliability and operation of the printing device. Therefore, it is desirable to use as little of the inorganic filler as possible when making opaque toner particles.

In the preferred approach to make opaque toner with low concentration of inorganic fillers, it is necessary to first prepare a masterbatch of the inorganic filler using a low viscosity polymer. The polymer selected for preparing the masterbatch would need to be sufficiently compatible with the binder used to prepare the opaque toner. According to this invention, a masterbatch of the desired inorganic fillers having a refractive index of greater than 1.75 needs to be prepared first. When such masterbatches were used as a component of the toner formulation, unexpectedly good dispersion of inorganic fillers was achieved in the resulting opaque toner articles. This not only keeps the amount of inorganic filler necessary for the required opacity, but also keeps the melt viscosity and charging behavior of the toner from being affected. It is further possible to select the proper dispersing polymer for making the masterbatch so as to control the toner viscosity even further, if necessary. The first requirement of the dispersing polymer is to provide an excellent dispersion necessary to make an opaque toner.

The present invention also relates to a developer containing the opaque toner particles of the present invention.

The present invention further relates to a development system using the opaque toner particles of the present invention.

The present invention also relates to a method of printing on a substantially transparent or highly colored substrate using the above-identified opaque toner formulation of the present invention in addition to the standard CYMK process colors.

The invention, and its objects and advantages, will become more apparent in the detailed description of the preferred embodiment presented below.

### BRIEF DESCRIPTION OF THE DRAWINGS

In the detailed description of the preferred embodiment of the invention presented below, reference is made to the accompanying drawings, in which:

FIG. 1 is a schematic side elevational view, in cross-section, of a typical electrographic reproduction apparatus suitable for use with this invention;

FIG. 2 is a schematic side elevational view, in cross-section, of the reprographic image-producing portion of the electrographic reproduction apparatus of FIG. 1, on an enlarged scale;

FIG. 3 is a schematic side elevational view, in cross-section, of one printing module of the electrographic reproduction apparatus of FIG. 1, on an enlarged scale; and

FIG. 4 is a plot depicting the measured amount of visible wavelengths reflected by the opaque toner comprising 15 percent by weight of a predispersed inorganic filler with a refractive index of greater than 1.75.

### DETAILED DESCRIPTION OF THE INVENTION

One of the characteristics of a color image that is highly desired is its colorfulness or chroma. When color images are printed, they are typically printed using bright papers. As a consequence, images, which are printed on a bright white substrate, give the appearance of being highly colorful. On bright papers, the images provide the maximum colorfulness and chroma and thus appear to be of higher quality. When color images are printed on substantially transparent or highly colored substrates, the full color saturation is not achieved and the color images are perceived to be of poor quality. In order to recover the loss of color saturation, it is highly desirable to provide an opaque background for the color toner particles. This opaque toner could be used on substantially transparent substrates as well as those that are highly colored.

In order to prepare an opaque toner, which is capable of providing reflective background, inorganic filler needs to be incorporated in the toner formulation, which would increase the opacity of the toner to the extent that it is capable of reflecting at least 70%, preferably at least 90%, and even up to 100%, of the visible light that is incident on it. These inorganic fillers are selected such that their refractive index is greater than 1.75, preferably greater than about 10, and more preferably greater than about 50.

As stated previously, the inorganic fillers suitable for this application have a substantial incompatibility with the toner resins that are often used in the industry. To achieve the necessary opacity, it is typically required that the amount of inorganic filler is quite high. Due to the poor dispersion caused by the incompatibility with toner polymer or resin, the amount of inorganic filler required becomes even higher. This leads to problems with toner melt viscosity and charging, as described above.

These issues were unexpectedly addressed, when a masterbatch of suitable inorganic filler was first prepared in a separate compounding step. A masterbatch was first prepared using either a flusher or a hot roll mill or other suitable device at a compounding temperature that is sufficient to provide a necessary dispersion and melt viscosity. The masterbatch is then used as one of the toner components along with other toner components including toner resin. The amount of inorganic filler used in the preparation of the masterbatch would range from 20 to 70 percent by weight of the masterbatch. The dispersion polymer selected for preparing masterbatch should have its number average molecular weight of less than 10,000 so as to have a minimal effect on the final melt viscosity of the opaque toner. It was also found that the dispersion quality was further enhanced when the acid value (AV) of masterbatch polymer is greater than 2. There should be sufficient compatibility between the toner resin and the dispersing polymer so as not to cause dispersion issues with the inorganic filler in the opaque toner. Any incompatibility between the dispersion polymer and the toner resin could also result in the unwanted increase in the melt viscosity of the resulting opaque toner.

In one of the embodiments of this invention, an opaque toner would be imaged behind the standard CYMK color toners used to make the color image. The requirement of this opaque toner would be to reflect most of the light that is incident on it. This can be achieved by using an electrophotographic printer, which can print with more than just the four primary colors. By using the opaque toner in the first module, it would be imaged first onto the substantially transparent substrate and then other color particles would be developed subsequently on top of this opaque toner. When the color image is viewed from the front, where the color particles are imaged, a full colorful image would be perceived because the opaque toner layer would reflect most of the incident light back to the viewer. In this embodiment, the substantially transparent substrate is at the bottom of all toners.

In another embodiment, the standard color toners are placed over the substantially transparent substrate in a “mirror” like image. The opaque toner is then imaged over the standard color particles. The image when viewed through the substrate would appear to be in correct orientation. The advantage in this embodiment is that the image is now protected by the substrate. This could be an important application where physical protection of the printed information is paramount. Also, this would be a method of printing color images on a substantially transparent substrate if the non-image side has a layer of adhesive or something similar applied to it. Examples of this type of application would be window stickers or decals as well as other promotional items.

Yet another embodiment of this opaque toner is printing on very dark and colored opaque substrate. When color images are printed on highly colored substrates, the color properties of the image are compromised. Highly colored substrates are defined herein as those substrates which have a lightness (L*) value of less than 50. One approach to finding a solution to this problem would be to print the opaque toner first on the colored substrate. The standard CYMK color toners then could be imaged over the opaque layer to provide a full-color image with high saturation and chroma.

Preferably, the toner formulations of the present invention are used in two component toner/developer systems.

One or more toner resins may be present in the toner particles or toner formulations of the present invention. The toner particles can be any conventional size and preferably have a median volume diameter of from about 4 microns to about 30 microns. The toner binders employed in the opaque and image marking toners can be any conventional polymeric resin or combination of resins typically used in toner formulations using conventional amounts. The following discussion relates to optional components that can also be present in the toner particles or formulations employed in the present invention.

Polymers useful as toner binders in the practice of the present invention can be used alone or in combination and include those polymers conventionally employed in electrostatic toners Useful amorphous polymers which can readily be fused to a conventional receiving sheet to form a permanent image generally have a glass transition temperature of less than or equal to about 100° C., and typically within the range of from 50° C. to 100° C. Where other types of receiving elements are used, for example, metal plates such as certain printing plates, polymers having a glass transition temperature higher than the values specified above can be used. Preferably, toner particles prepared from these polymers have relatively high caking temperature, for example, higher than about 50° C., so that the toner powders can be stored for relatively long periods of time at fairly high temperatures without having individual particles agglomerate and clump together.

Among the various polymers which can be employed in the toner particles of the present invention are polycarbonates, resin-modified maleic alkyd polymers, polyamides, phenol-formaldehyde polymers and various derivatives thereof polyester condensates, modified alkyd polymers, aromatic polymers containing alternating methylene and aromatic units such as described in U.S. Pat. No. 3,809,554 and fusible crosslinked polymers as described in U.S. Pat. No. Re. 31,072.

Useful binder polymers include vinyl polymers, such as homopolymers and copolymers of styrene. Styrene polymers include those containing 40 to 100 percent by weight of styrene, or styrene homologs, and from 0 to 40 percent by weight of one or more lower alkyl acrylates or methacrylates. Other examples include fusible styrene-acrylic copolymers that are covalently lightly crosslinked with a divinyl compound such as divinylbenzene. Preferred binders comprise styrene and an alkyl acrylate and/or methacrylate, and the styrene content of the binder is preferably at least about 60% by weight.

Copolymers rich in styrene such as styrene butylacrylate and styrene butadiene are also useful as binders as are blends of polymers. In such blends, the ratio of styrene butylacrylate to styrene butadiene can be 10:1 to 1:10. Ratios of 5:1 to 1:5 and 7:3 are particularly useful. Polymers of styrene butylacrylate and/or butylmethacrylate (30 to 80% styrene) and styrene butadiene (30 to 90% styrene) are also useful binders. A useful binder can also be formed from a copolymer of a vinyl aromatic monomer, a second monomer selected from either conjugated diene monomers or acrylate monomers such as alkyl acrylate and alkyl methacrylate.

Styrene polymers include styrene, alpha-methylstyrene, para-chlorostyrene, and vinyl toluene; and alkyl acrylates or methylacrylates or monocarboxylic acids having a double bond selected from acrylic acid, methyl acrylate, 2-ethylhexyl acrylate, 2-ethylhexyl methacrylate, ethyl acrylate, butyl acrylate, dodecyl acrylate, octyl acrylate, phenylacrylate, methylacrylic acid, ethyl methacrylate, butyl methacrylate and octyl methacrylate and are also useful binders. Also useful are condensation polymers such as polyesters and copolyesters of aromatic dicarboxylic acids with one or more aliphatic diols, such as polyesters of isophthalic or terephthalic acid with diols such as ethylene glycol, cyclohexane dimethanol, and bisphenols.

Typical useful toner polymers include certain polycarbonates such as those described in U.S. Pat. No. 3,694,359, which include polycarbonate materials containing an alkylidene diarylene moiety in a recurring unit and having from 1 to about 10 carbon atoms in the alkyl moiety. Other useful polymers having the above-described physical properties include polymeric esters of acrylic and methacrylic acid such as poly(alkyl acrylate), and poly(alkyl methacrylate) wherein the alkyl moiety can contain from 1 to about 10 carbon atoms.

Additionally, other polyesters having the aforementioned physical properties are also useful. Among such other useful polyesters are copolyesters prepared from terepbthalic acid (including substituted terephthalic acid), a bis[(hydroxyalkoxy)phenyl]alkane having from 1 to 4 carbon atoms in the alkoxy radical and from 1 to 10 carbon atoms in the alkane moiety (which can also be a halogen-substituted alkane), and an alkylene glycol having from 1 to 4 carbon atoms in the alkylene moiety.

Another necessary component of the opaque toner of this invention is an inorganic filler which has a refractive index of greater than 1.75, preferably greater than about 10, and more preferably greater than about 50. This inorganic filler must also be obtainable in a pure chemical state so it doesn't fluoresce or phosphoresce, that is give off light different from the light shining on it. It should have a high refractive index, a high ability to bend light that strikes it obliquely. The refractive index of typical toner polymers around 1.55. It was found that when inorganic fillers were used which had a refractive index of greater than 1.75, sufficient opacity was achieved in the opaque toner for the intended application. There are many opaque materials that are more chemically inert and are used as pigments. Examples of such inorganic fillers include, but are not limited to, silica (SiO2), chalk ( Calcium carbonate, CaCO3), titania (Titanium dioxide TiO2), zirconia (Zirconium dioxide, ZrO2), baryta (Barium sulfate, BaSO4), gypsum (Calcium sulfate, CaSO4), powdered glass, zinc oxide (ZnO), and zinc sulfide (ZnS). Among the many inorganic fillers that are currently available, the most preferred inorganic filler is titanium dioxide. There are two crystal structures that exist for titanium dioxide—anatase and rutile. However, the rutile form scatters light more efficiently between the two, and hence is more preferable than the anatase form. The amount of inorganic filler necessary for producing an opaque toner would typically range from 5 to 25 percent by weight of the opaque toner, more typically 10 to 25 percent by weight.

Selection of the dispersion polymer for masterbatches was found to be very critical to the final toner properties. To enable compatibility with the toner binder itself, the composition of the dispersing polymer preferably may be selected from the possible choices available for toner binders that are described above. Just like the toner polymer, the dispersing polymer may also be an amorphous polymer having a glass transition temperature of greater than 50° C. Although the dispersing polymer is very similar to the toner binder in composition, it is typically different in one aspect, that is, its weight average molecular weight is preferably less than that of the toner binder. Further preferably, the dispersing polymer number average molecular weight is less than 10,000, even more preferably less than 5,000. Polymer binders that have very low molecular weight tend to be extremely brittle and do not function well as toner resins all by themselves. There should be sufficient compatibility or miscibility between the toner resin and the dispersing polymer so as not to cause dispersion issues with the inorganic filler in the opaque toner. Any incompatibility between the dispersion polymer and the toner resin could also result in the unwanted increase in the melt viscosity of the resulting opaque toner. The dispersing polymer selected for preparing masterbatch should accordingly have its number average molecular weight of less than 10,000, or more preferably less than 5,000 so as to have a minimal effect on the final melt viscosity of the opaque toner. If the dispersing polymer was too high a viscosity, then good dispersion may not be obtained and further, the melt viscosity of the resulting toner may also be too high to be useful. It was also found that the dispersion quality is further enhanced when the acid value (AV) of masterbatch polymer is greater than 2.0 mgKOH/g wherein the acid value is measured by the end point determination for a polymer solution using dilute potassium hydroxide solution. The amount of inorganic filler used in the preparation of the masterbatch would range from 20 to 70 percent by weight of the masterbatch. These predispersed masterbatches can be prepared using a flusher, a hot roll mill, or any other suitable device at a compounding temperature that is sufficient to provide a necessary dispersion and melt viscosity.

Typically, the amount of toner resin present in the toner formulation is from about 75 to about 90. Various kinds of well-known addenda (e.g., colorants, release agents, etc.) can also be incorporated into the toners of the invention.

An optional additive for toner is a colorant. Numerous colorant materials selected from dyestuffs or pigments can be employed in the toner materials employed in the present invention. Such materials serve to color the toner and/or render it more visible. Of course, suitable toner materials having the appropriate charging characteristics can be prepared without the use of a colorant material where it is desired to have a developed image of low optical density. In those instances where it is desired to utilize a colorant, the colorants can, in principle, be selected from virtually any of the compounds.

Suitable dyes and pigments are disclosed, for example, in U.S. Reissue Pat. No. 31,072 and in U.S. Pat. Nos. 4,160,644; 4,416,965; 4,414,152; and 4,229,513, all incorporated in their entireties by reference herein. Colorants are generally employed in the range of from about 1 to about 30 weight percent on a total toner powder weight basis, and preferably in the range of about 2 to about 15 weight percent. The toner particles can include one or more toner resins which can be optionally colored by one or more colorants by compounding the resin(s) with at least one colorant and any other ingredients. Although coloring is optional, normally a colorant is included in image marking particles, and can be any of the materials mentioned in Colour Index, Volumes I and II, Second Edition, incorporated herein by reference. In some cases a magnetic component, if present, acts as a colorant negating the need for a separate colorant.

In addition, an optional aliphatic, olefinic or polyalkylene wax can also be used to provide assistance with fuser release as well as improved abrasion protection. The waxes present in the opaque toner of this invention preferably have a melting temperature onset of from about 65° C. to about 130° C. The melting temperature onset is calculated by identifying the temperature at which a melting transition is exhibited first in a Differential Scanning Calorimeter (DSC) scan by showing a departure from the baseline. DSC scans were obtained using a Perkin Elmer DSC 7. A toner weight of 10 to 20 mg was used at a heating and cooling rate of 10° C. per minute.

Examples of suitable polyalkylene waxes include, but are not limited to, polyethylene or polypropylene, such as Peterolite POLYWAX 2000 and POLYWAX 3000, VISCOL 550 or 660 from Sanyo, LICOWAX PE 130 and PE 190 from Clariant Chemicals, and the like. Also useful are ester waxes available from Nippon Oil and Fat under the WE-series waxes.

The amount of the polyalkylene wax employed can be any suitable amount to accomplish the benefits mentioned herein. Examples of suitable amounts include, but are not limited to, from about 0.1 to about 10 weight percent and more preferably from about 1 to about 6 weight percent based on the toner weight. Other suitable amounts are from about 1 part to about 5 parts based on a 100 parts by weight of the toner resin present. Though not necessary, other conventional waxes can be additionally present, such as other polyolefin waxes and the like.

At least one charge control agent can be present in the toner formulations of the present invention. The term “charge-control” refers to a propensity of a toner addendum to modify the triboelectric charging properties of the resulting toner. A very wide variety of charge control agents for positive and negative charging toners are available. Suitable charge control agents are disclosed, for example, in U.S. Pat. Nos. 3,893,935; 4,079,014; 4,323,634; 4,394,430; and British Patent Nos. 1,501,065 and 1,420,839, all of which are incorporated in their entireties by reference herein. Additional charge control agents, which are useful, are described in U.S. Pat. Nos. 4,624,907; 4,814,250; 4,840,864; 4,834,920; 4,683,188; and 4,780,553, all of which are incorporated in their entireties by reference herein. Mixtures of charge control agents can also be used. Particular examples of charge control agents include chromium salicylate organo-complex salts, and azo-iron complex-salts, an azo-iron complex-salt, particularly ferrate (1-), bis[4-[(5-chloro-2-hydroxyphenyl)azo]-3-hydroxy-N-phenyl-2-napbthalenecarboxamidato(2-)], ammonium, sodium, and hydrogen (Organoiron available from Hodogaya Chemical Company Ltd.).

Additional examples of suitable charge control agents include, but are not limited to, acidic organic charge control agents. Particular examples include, but are not limited to, 2,4-dihydro-5-methyl-2-phenyl-3H-pyrazol-3-one (MPP) and derivatives of MPP such as 2,4-dihydro-5-methyl-2-(2,4,6-trichlorophenyl)-3H-pyrazol-3-one, 2,4-dihydro-5-methyl-2-(2,3,4,5,6-pentafluorophenyl)-3H-pyrazol-3-one, 2,4-dihydro-5-methyl-2-(2-trifluoromethylphenyl)-3H-pyrazol-3-one and the corresponding zinc salts derived therefrom. Other examples include charge control agents with one or more acidic functional groups, such as fumaric acid, malic acid, adipic acid, terephathalic acid, salicylic acid, fumaric acid monoethyl ester, copolymers of styrene/methacrylic acid, copolymers of styrene and lithium salt of methacrylic acid, 5,5′-methylenedisalicylic acid, 3,5-di-t-butylbenzoic acid, 3,5-di-t-butyl-4-hydroxybenzoic acid, 5-t-octylsalicylic acid, 7-t-butyl-3-hydroxy-2-napthoic acid, and combinations thereof. Still other acidic charge control agents which are considered to fall within the scope of the invention include N-acylsulfonamides, such as, N-(3,5-di-t-butyl-4-hydroxybenzoyl)-4-chlorobenzenesulfonamide and 1,2-benzisothiazol-3(2H)-one 1,1-dioxide.

Another class of charge control agents include, but are not limited to, iron organo metal complexes such as organo iron complexes. A particular example is T77 from Hodogaya.

Preferably, the charge control agent is capable of providing a charge. For purposes of the present invention, a preferred consistent level of charge is from about −30 to about −60 micro C/gm for an 8 micron volume average median particle size toner.

The charge control agent(s) is generally present in the toner formulation in an amount to provide a consistent level of charge and preferably provide a consistent level of charge of from about −30 to about −60 micro C/gm in the toner formulation upon being charged. Examples of suitable amounts include from about ½ part to about 6 parts per 100 parts of resin present in the toner formulation.

With respect to the surface treatment agent, also known as a spacing agent, the amount of the agent on the toner particles is an amount sufficient to permit the toner particles to be stripped from the carrier particles in a two component system by the electrostatic forces associated with the charged image or by mechanical forces. Preferred amounts of the spacing agent are from about 0.05 to about 1.5 weight percent, and more preferably from about 0.1 to about 1.0 weight percent, and most preferably from about 0.2 to 0.6 weight percent, based on the weight of the toner.

The spacing agent can be applied onto the surfaces of the toner particles by conventional surface treatment techniques such as, but not limited to, conventional powder mixing techniques, such as tumbling the toner particles in the presence of the spacing agent. Preferably, the spacing agent is distributed on the surface of the toner particles. The spacing agent is attached onto the surface of the toner particles and can be attached by electrostatic forces, or physical means, or both. With mixing, preferably uniform mixing is preferred and achieved by such mixers as a high energy Henschel-type mixer which is sufficient to keep the spacing agent from agglomerating or at least minimizes agglomeration. Furthermore, when the spacing agent is mixed with the toner particles in order to achieve distribution on the surface of the toner particles, the mixture can be sieved to remove any agglomerated spacing agent or agglomerated toner particles. Other means to separate agglomerated particles can also be used for purposes of the present invention. The mixing conditions should be gentle enough such that the large toner particles are not fractured by the collision with the wall of the Henschel mixer as they are agitated by the mixing blade/propeller. At too high a mixing speed, generation of fine particles is often observed with larger toner particles owing to their large mass.

The preferred spacing agent is silica, such as those commercially available from Degussa, like R972, RY200 or from Wacker, like H2000. Other suitable spacing agents include, but are not limited to, other inorganic oxide particles and the like. Specific examples include, but are not limited to, titania, alumina, zirconia, and other metal oxides; and also polymer beads preferably less than 1 μm in diameter (more preferably about 0.1 μm), such as acrylic polymers, silicone-based polymers, styrenic polymers, fluoropolymers, copolymers thereof, and mixtures thereof. These metal oxide particles can be optionally treated with a silane or silicone coating to alter their hydrophobic character. In the preferred embodiment, a mixture of hydrophobic silica is used along with the hydrophobic titania to provide the optimum results for charging behavior and powder flow properties.

The toner formulations can also contain other additives of the type used in conventional toners, including magnetic pigments, colorants, leveling agents, surfactants, stabilizers, and the like.

In a typical manufacturing process, the desired polymeric binder for toner application is produced independently. Polymeric binders for clectrostatographic toners are commonly made by polymerization of selected monomers followed by mixing with various additives and then grinding to a desired size range. During toner manufacturing, the polymeric binder is subjected to melt processing in which the polymer is exposed to moderate to high shearing forces and temperatures in excess of the glass transition temperature of the polymer. The temperature of the polymer melt results, in part, from the frictional forces of the melt processing. The melt processing includes melt-blending of toner addenda into the bulk of the polymer.

The melt product is cooled and then pulverized to a volume average particle size of from about 18 to 50 micrometers. It is generally preferred to first grind the melt product prior to a specific pulverizing operation. The grinding can be carried out by any convenient procedure. For example, the solid toner can be crushed and then ground using, for example, a fluid energy or jet mill, such as described in U.S. Pat. No. 4,089,472, and can then be classified in one or more steps. The size of the particles is then further reduced by use of a high shear pulverizing device such as a fluid energy mill.

In place of melt blending or the like, the polymer can be dissolved in a solvent in which the charge control agent and other additives are also dissolved or are dispersed. The resulting solution can be spray dried to produce particulate toner powders. Limited coalescence polymer suspension procedures as disclosed in U.S. Pat. No. 4,833,060 are particularly useful for producing small sized, uniform toner particles. The toner formulation may also be made using various chemical methods known in the toner industry. Other methods include those well-known in the art such as spray drying, melt dispersion, and dispersion polymerization.

The shape of the toner particles can be any shape, regular or irregular, such as spherical particles, which can be obtained by spray-drying a solution of the toner resin in a solvent. Alternatively, spherical particles can be prepared by the polymer bead swelling techniques, such as those described in European Patent No. 3905 published Sep. 5, 1979, which is incorporated in its entirety by reference herein.

To be utilized as toners in an electrostatographic developer, the toners of this invention can be mixed with a carrier vehicle. The carrier vehicles, which can be used with the present toners to form the new developer can be selected from a variety of materials. Such materials include carrier core particles and core particles overcoated with a thin layer of a film-forming resin.

The carrier core materials can comprise conductive, non-conductive, magnetic, or non-magnetic materials. For example, carrier cores can comprise glass beads; crystals of inorganic salts such as aluminum potassium chloride; other salts such as ammonium chloride or sodium nitrate; granular zircon; granular silicon; silicon dioxide; hard resin particles such as poly(methyl methacrylate); metallic materials such as iron, steel, nickel, carborundum, cobalt, oxidized iron; or mixtures or alloys of any of the foregoing. See, for example, U.S. Pat. Nos. 3,850,663 and 3,970,571. Especially useful in magnetic brush development schemes are iron particles such as porous iron particles having oxidized surfaces, steel particles, and other “hard” or “soft” ferromagnetic materials such as gamma ferric oxides or ferrites, such as ferrites of barium, strontium, lead, magnesium, or aluminum. See, for example, U.S. Pat. Nos. 4,042,518; 4,478,925; and 4,546,060. The preferred hard magnetic carrier particles can exhibit a coercivity of at least about 300 gauss when magnetically saturated and also exhibit an induced magnetic moment of at least about 20 EMU/gm when in an externally applied field of 1,000 gauss. The magnetic carrier particles can be binder-less carriers or composite carriers. Useful hard magnetic materials include ferrites and gamma ferric oxide.

In one preferred embodiment, the carrier particles are composed of ferrites, which are compounds of magnetic oxides containing iron as a major metallic component. For example, compounds of ferric oxide, Fe₂O₃, formed with basic metallic oxides such as those having the general formula MFeO₂ or MFe₂O₄ wherein M represents a mono- or di-valent metal and the iron is in the oxidation state of +3. Preferred ferrites are those containing barium and/or strontium, such as BaFe₁₂O₁₉, SrFe₁₂O₁₉, and the magnetic ferrites having the formula MO.6 Fe₂O₃, wherein M is barium, strontium, or lead as disclosed in U.S. Pat. No, 3,716,630 which is incorporated in its entirety by reference herein. The size of the magnetic carrier particles useful in the present invention can vary widely, and preferably have an average particle size of less than 100 microns, and more preferably have an average carrier particle size of from about 25 to about 50 microns.

As noted above, the carrier particles can be overcoated with a thin layer of a film-forming resin for the purpose of establishing the correct triboelectric relationship and charge level with the toner employed. Examples of suitable resins are the polymers described in U.S. Pat. Nos. 3,547,822; 3,632,512; 3,795,618; 3,898,170 and Belgian Pat. No. 797,132. Other useful resins are fluorocarbons such as polytetrafluoroethylene, poly(vinylidene fluoride), mixtures of these and copolymers of vinylidene fluoride and tetrafluoroethylene. See, for example, U.S. Pat. Nos. 4,546,060; 4,478,925; 4,076,857; and 3,970,571. Such polymeric fluorocarbon carrier coatings can serve a number of known purposes. One such purpose can be to aid the developer to meet the electrostatic force requirements mentioned above by shifting the carrier particles to a position in the triboelectric series different from that of the uncoated carrier core material, in order to adjust the degree of triboelectric charging of both the carrier and toner particles. Another purpose can be to reduce the frictional characteristics of the carrier particles in order to improve developer flow properties. Still another purpose can be to reduce the surface hardness of the carrier particles so that they are less likely to break apart during use and less likely to abrade surfaces (e.g., photoconductive element surfaces) that they contact during use. Yet another purpose can be to reduce the tendency of toner material or other developer additives to become undesirably permanently adhered to carrier surfaces during developer use (often referred to as scumming). A further purpose can be to alter the electrical resistance of the carrier particles. Examples of other suitable resin materials for the carrier particles include, but are not limited to, silicone resin, fluoropolymers, polyacrylics, polymethacrylics, copolymers thereof, and mixtures thereof, other commercially available coated carriers, and the like.

A typical developer containing the above-described toner and a carrier vehicle generally comprises from about 1 to about 25 percent by weight of particulate toner particles and from about 75 to about 99 percent by weight carrier particles. Usually, the carrier particles are larger than the toner particles. Conventional carrier particles have a particle size on the order of from about 20 to about 200 micrometers. For the preferred hard ferrite carrier particles, the volume average particle size should range from 15 to 60 microns.

Developers in the development system of the present invention are preferably capable of delivering toner to a charged image at high mass flow rates and hence are particularly suited to high-volume electrophotographic printing applications and copying applications.

The toner and developer described can be used in a variety of ways to develop electrostatic charge patterns or latent images. Such developable charge patterns can be prepared by a number of means and be carried for example, on a light sensitive photoconductive element or a non-light-sensitive dielectric-surfaced element such as an insulator-coated conductive sheet. One suitable development technique involves cascading the developer across the electrostatic charge pattern, while another technique involves applying toner particles from a magnetic brush. This latter technique involves the use of a magnetically attractable carrier vehicle in forming the developer. After imagewise deposition of the toner particles, the image can be fixed, e.g., by heating the toner to cause it to fuse to the substrate carrying the toner. If desired, the unfused image can be transferred to a receiver such as a blank sheet of copy paper and then fused to form a permanent image.

In more detail, such a set up of the development system is available in a digital printer, such as NEXPRESS 3000 digital printer using a development station comprising a non-magnetic, cylindrical shell, a magnetic core, and means for rotating the core and optionally the shell as described, for instance, in detail in U.S. Pat. Nos. 4,473,029 and 4,546,060, both incorporated in their entirety herein by reference. The development systems described in these patents can be adapted for use in the present invention. In more detail, the development systems described in these patents preferably use hard magnetic carrier particles.

The present invention further relates to the use of the above-described development system in developing electrostatic images with the toner of the present invention. The method involves contacting an electrostatic image with the toner of the present invention. For example, the method involves developing an electrostatic image member bearing an electrostatic image pattern by moving the image member through a development zone and transporting developer through the development zone in developing relation with the charge pattern of the moving imaging member by rotating an alternating-pole magnetic core of a pre-selected magnetic field strength within an outer non-magnetic shell, which can be rotating or stationary, and controlling the directions and speeds of the core and optionally the shell rotations so that developer flows through the development zone in a direction co-current with the image member movement, wherein an electrographic two-component dry developer is preferably used. The dry developer contains charged toner particles and oppositely charged carrier particles.

The electrostatic image so developed can be formed by a number of methods such as by image-wise photo decay of a photoreceptor or image-wise application of a charge pattern on the surface of a dielectric recording element. When photoreceptors are used, such as in high-speed electrophotographic copy devices, the use of half-tone screening to modify an electrostatic image is particularly desirable; the combination of screening with development in accordance with the method of the present invention producing high-quality images exhibiting high Dmax and excellent tonal range. Representative screening methods include those employing photoreceptors with integral half-tone screen, such as those described in U.S. Pat. No. 4,385,823, incorporated in its entirety by reference herein.

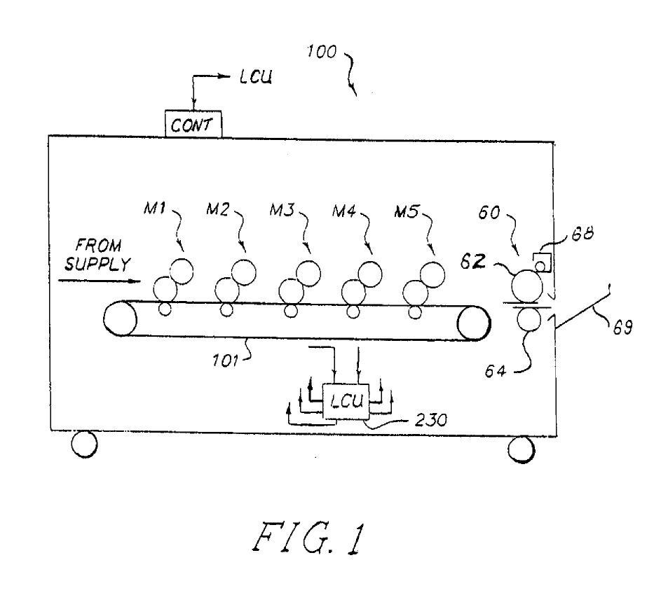

Referring now to the accompanying drawings, FIGS. 1-3 are side elevational views schematically showing portions of a typical electrographic print engine or printer apparatus suitable for printing of pentachrome images. Although one embodiment of the invention involves printing using an electrophotographic engine having five sets of single color image producing or printing stations or modules arranged in tandem, the invention contemplates that more or less than five different toners may be combined on a single receiver member, or may include other typical electrographic writers or printer apparatus.

An electrographic printer apparatus 100 has a number of tandemly arranged electrostatographic image forming printing modules M1, M2, M3, M4, and M5. Each of the printing modules generates a single-color toner image or opaque toner layer for transfer to a receiver member successively moved through the modules. Each receiver member, during a single pass through the five modules, can have transferred in registration thereto up to five toner images to form a final composite image. An image formed on a receiver member may comprise combinations of subsets of the colors combined to form other colors on the receiver member at various locations on the receiver member, and all colors may participate to form process colors in at least some of the subsets wherein each of the colors may be combined with one or more of the other colors at a particular location on the receiver member to form a color different than the specific color toners combined at that location.

In a particular embodiment, four of the printing modules M1-M5 form a black (K) toner color separation images, a yellow (Y) toner color separation images, a magenta (M) toner color separation images, and a cyan (C) toner color separation images, while one of the modules (typically either the first or last printing module) is used to form an opaque toner layer for printing on substantially transparent or highly colored substrates. It is well known that the four primary colors cyan, magenta, yellow, and black may be combined in various combinations of subsets thereof to form a representative spectrum of colors and having a respective gamut or range dependent upon the materials used and process used for forming the colors. However, in the electrographic printer apparatus, additional printing modules may also be employed, such that a fifth color can be added to improve the color gamut. In addition to adding to the color gamut, such additional printing modules may also be used as a specialty color toner image, such as for making proprietary logos.

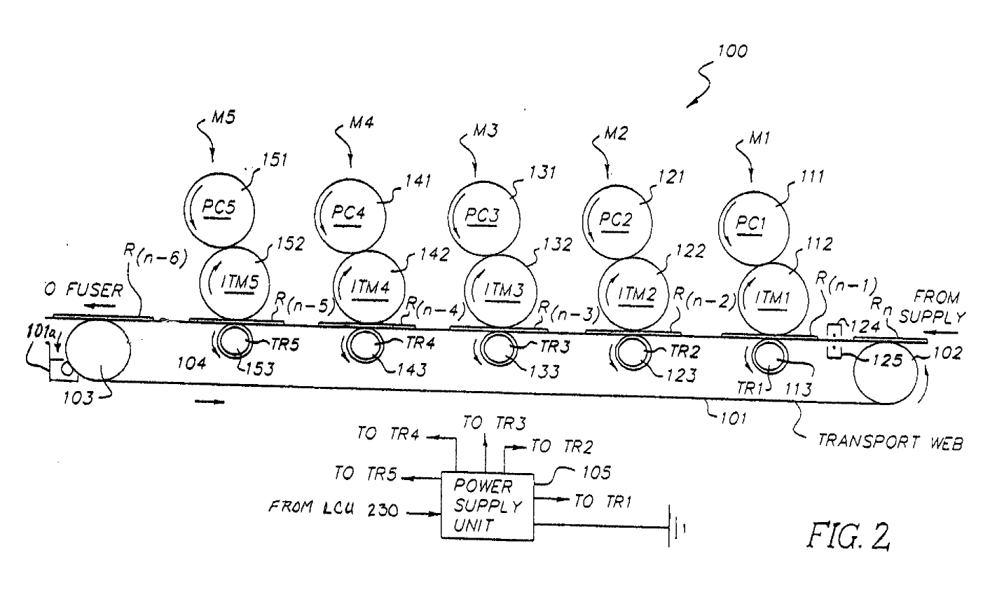

Receiver members (Rₙ-R₍ₙ₋₆) as shown in FIG. 2) are delivered from a paper supply unit (not shown) and transported through the printing modules M1-M5. The receiver members are adhered (e.g., preferably electrostatically via coupled corona tack-down chargers 124, 125) to an endless transport web 101 entrained and driven about rollers 102, 103. Each of the printing modules M1-M5 similarly includes a photoconductive imaging roller, an intermediate transfer member roller, and a transfer backup roller. Thus in printing module M1, a black color toner separation image can be created on the photoconductive imaging roller PC1 (111), transferred to intermediate transfer member roller ITM1 (112), and transferred again to a receiver member moving through a transfer station, which transfer station includes ITM1 forming a pressure nip with a transfer backup roller TR1 (113).

Similarly, printing modules M2, M3, M4, and M5 include, respectively: PC2, ITM2, TR2 (121, 122, 123); PC3, ITM3, TR3 (131, 132, 133); PC4, ITM4, TR4 (141, 142, 143); and PC5, ITM5, TR5 (151, 152, 153). A receiver member, Rₙ, arriving from the supply, is shown passing over roller 102l for subsequent entry into the transfer station of the first printing module, M1, in which the preceding receiver member R₍ₙ₋₁₎ is shown. Similarly, receiver members R₍ₙ₋₂₎, R₍ₙ₋₃₎, R₍ₙ₋₄₎, and R₍ₙ₋₅₎ are shown moving respectively through the transfer stations of printing modules M2, M3, M4, and M5. An unfused image formed on receiver member R₍ₙ₋₆₎ is moving as shown towards a fuser of any well known construction, such as the fuser assembly 60 (shown in FIG. 1).

A power supply unit 105 provides individual transfer currents to the transfer backup rollers TR1, TR2, TR3, TR4, and TR5 respectively. A logic and control unit 230 (FIG. 1) includes one or more computers and in response to signals from various sensors associated with the electrographic printer apparatus 100 provides timing and control signals to the respective components to provide control of the various components and process control parameters of the apparatus in accordance with well understood and known employments. A cleaning station 101a for transport web 101 is also typically provided to allow continued reuse thereof.

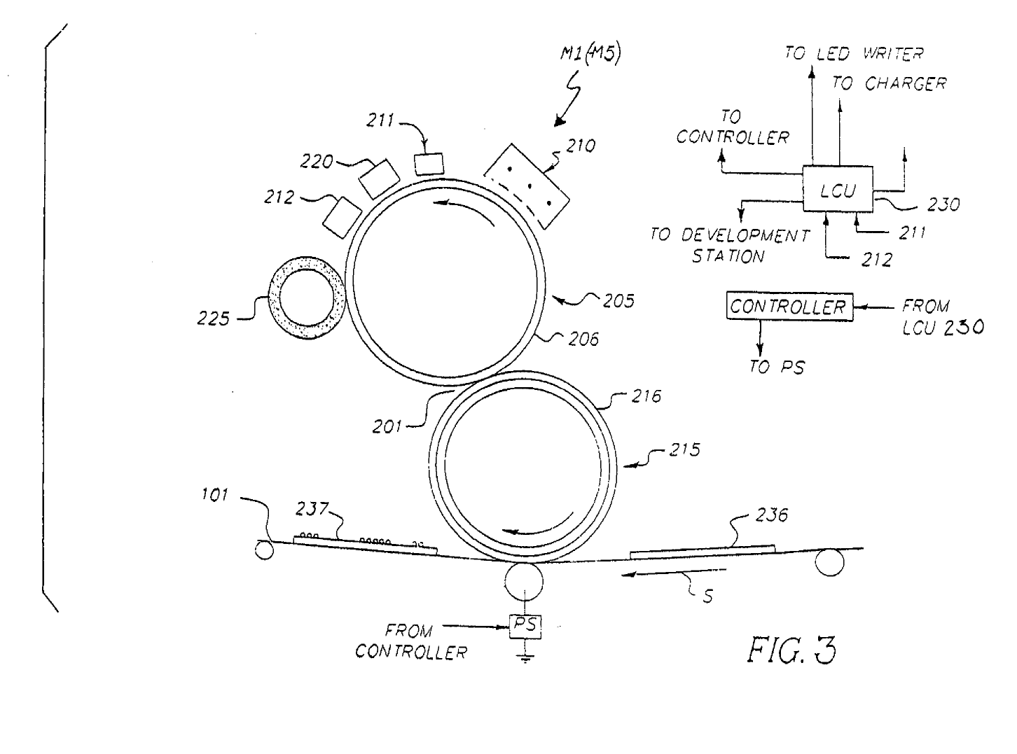

With reference to FIG. 3 wherein a representative printing module (e.g, M1 of M1-M5) is shown, each printing module of the electrographic printer apparatus 100 includes a plurality of electrographic imaging subsystems for producing a single color toned image. Included in each printing module is a primary charging subsystem 210 for uniformly electrostatically charging a surface 206 of a photoconductive imaging member (shown in the form of an imaging cylinder 205). An exposure subsystem 220 is provided for image-wise modulating the uniform electrostatic charge by exposing the photoconductive imaging member to form a latent electrostatic color separation image of the respective color. A development station subsystem 225 serves for toning the image-wise exposed photoconductive imaging member with toner of a respective color. An intermediate transfer member 215 is provided for transferring the respective color separation image from the photoconductive imaging member through a transfer nip 201 to the surface 216 of the intermediate transfer member 215 and from the intermediate transfer member 215 to a receiver member (receiver member 236 shown prior to entry into the transfer nip and receiver member 237 shown subsequent to transfer of the toned color separation image) which receives the respective toned color separation images in superposition to form a composite multicolor image thereon.

Subsequent to transfer of the respective color separation images and opaque toner layer, overlaid in registration, one from each of the respective printing modules M1-M5, the receiver member is advanced to a fusing assembly to fuse the multicolor toner image to the receiver member. Additional necessary components provided for control may be assembled about the various process elements of the respective printing modules (e.g., a meter 211 for measuring the uniform electrostatic charge, a meter 212 for measuring the post-exposure surface potential within a patch area of a patch latent image formed from time to time in a non-image area on surface 206, etc). Further details regarding the electrographic printer apparatus 100 are provided in US Publication No. 2006/0133870, published on Jun. 22, 2006, in the name of Yee S. Ng et al.

Associated with the printing modules is a main printer apparatus logic and control unit (LCU) 230, which receives input signals from the various sensors associated with the printer apparatus and sends control signals to the chargers 210, the exposure subsystem 220 (e.g., LED writers), and the development stations 225 of the printing modules M1-M5. Each printing module may also have its own respective controller coupled to the printer apparatus main LCU 230.

Subsequent to the transfer of the five toner images in superposed relationship to each receiver member, the receiver member is then serially de-tacked from transport web 101 and sent in a direction to the fusing assembly 60 to fuse or fix the dry toner images to the receiver member. The transport web is then reconditioned for reuse by cleaning and providing charge to both surfaces (see FIG. 2), which neutralizes charge on the opposed surfaces of the transport web 101.

The electrostatic image is developed by application of pigmented marking particles (toner) to the latent image bearing photoconductive drum by the respective development station 225. Each of the development stations of the respective printing modules M1-M5 is electrically biased by a suitable respective voltage to develop the respective latent image, which voltage may be supplied by a common power supply or by individual power supplies (not illustrated). Preferably, the respective developer is a two-component developer that includes toner marking particles and magnetic carrier particles.

Each development station has a particular color of pigmented toner marking particles, or opaque toner particles, associated respectively therewith for toning. Thus, each of the five modules creates a different color marking particle image or opaque toner layer on the respective photoconductive drum. As discussed above, an opaque toner development station may operate in similar manner to that of the other printing modules, which deposit pigmented tone for image marking. The development station of the opaque toner printing module has toner particles associated respectively therewith that are similar to the toner marking particles of the color development stations, but contain predispersed inorganic filler with a refractive index of greater than 1.75 incorporated within the toner binder, and preferably without the colored pigments contained in the image marking toner particles.

With further reference to FIG. 1, transport web 101 transports the toner image carrying receiver members to a fusing or fixing assembly 60, which fixes the toner particles to the respective receiver members by the application of heat and pressure. More particularly, fusing assembly 60 includes a heated fusing roller 62 and an opposing pressure roller 64 that form a fusing nip there between. Fusing assembly 60 also includes a release fluid application substation generally designated 68 that applies release fluid, such as, for example, silicone oil, to fusing roller 62. The receiver members carrying the fused image are transported seriatim from the fusing assembly 60 along a path to either a remote output tray 69, or returned to the image forming apparatus to create an image on the backside of the receiver member (forming a duplex print) for the purpose to be described below.

The logic and control unit (LCU) 230 includes a microprocessor incorporating suitable look-up tables and control software, which is executable by the LCU 230. The control software is preferably stored in memory associated with the LCU 230. Sensors associated with the fusing assembly provide appropriate signals to the LCU 230. In response to the sensors, the LCU 230 issues command and control signals that adjust the heat and/or pressure within fusing nip between rollers 62 and 64 and otherwise generally nominalizes and/or optimizes the operating parameters of fusing assembly 60 for imaging substrates.

Image data for writing by the printer apparatus 100 may be processed by a raster image processor (RIP), which may include a color separation screen generator or generators. The output of the RIP may be stored in frame or line buffers for transmission of the color separation print data to each of the respective LED writers K, Y, M, C, and O (which stand for black, yellow, magenta, cyan, and opaque, respectively, and assuming that the fifth color is opaque). The RIP and/or color separation screen generator may be a part of the printer apparatus or remote there from. Image data processed by the RIP may be obtained from a color document scanner or a digital camera or generated by a computer or from a memory or network which typically includes image data representing a continuous image that needs to be reprocessed into halftone image data in order to be adequately represented by the printer.

The RIP may perform image processing processes including color correction, etc. in order to obtain the desired color print. Color image data is separated into the respective colors and converted by the RIP to halftone dot image data in the respective color using matrices, which comprise desired screen angles and screen rulings. The RIP may be a suitably programmed computer and/or logic devices and is adapted to employ stored or generated matrices and templates for processing separated color image data into rendered image data in the form of halftone information suitable for printing.

According to this invention, the desire to print opaque toner, can be accomplished with an electrographic reproduction apparatus, such as the apparatus 100 discussed above, by controlling the amount of opaque toner particles on a receiver member Rₙ. (see FIGS. 1-3). As discussed above, the opaque particles either over or under the colored making particles can have various applications such as to provide a colorful image on a substantially transparent receiver or as highly colored substrate. The toner of this invention can also be placed in selective areas to provide opacity only where needed or to enhance the image in some manner.

When printing with opaque toner in one of the electrographic modules, it may be advantageous to alter one or more electrographic process set-points, or operating algorithms, to optimize performance, reliability, and/or image quality of the resultant print. Examples of electrographic process set-point (or operating algorithms) values that may be controlled in the electrographic printer to alternate predetermined values when printing opaque toner include, for example: imaging voltage on the photoconductive member, toner particle development voltage, transfer voltage and transfer current. In addition, the set-points of the fixing assembly may also be altered for printing opaque toner, such as fusing temperature, fusing nip width, and fusing nip pressure. In an electrographic apparatus that produces prints with opaque toner, a special mode of operation may be provided where the predetermined set-points (or control parameters or algorithms) are used when printing with such opaque toner in the fifth module. That is, when the electrographic printing apparatus prints standard CYMK information images, a first set of set-points/control parameters are utilized. Then, when the electrographic printing apparatus changes mode to print opaque toner undercoat or overlay on images, a second set of set-points/control parameters are utilized.

Alternatively, several layers of the standard CYMK toner particles can be selectively covered in the desired amount of toner particles that provide opaque feature. The opaque toner particles are preferably white and have a lay down coverage of no more than 0.6 mg/cm . Optionally, these opaque toner particles may comprise one or more pigments or other additives to impart special hue or appearance.

The use of opaque toner in printing sequence could take place either before printing of the standard CYMK process colors or after all the process colors have been printed. It would be necessary to print the opaque toner first when it is desirable to print on a highly colored substrate. This would provide sufficient background to reflect most of the incident light. This mode would also be useful for a sufficiently transparent receiver when the color image is placed in front of the substrate from the viewing angle. The opaque toner would be imaged after the standard CYMK toner when it is desirous to protect the color image. In such a case the protection is being provided by the substrate itself. The color image would need to be printed as a mirror image to account for the viewing angle, which would be through the substrate.

In all of these approaches, a clear toner may be further applied on top of a color image to form a three-dimensional texture. It should be kept in mind that textural information corresponding to the clear toner image plane need not be binary. In other words, the quantity of clear toner called for, on a pixel by pixel basis, need not only assume either 100% coverage or 0% coverage; it may call for intermediate “gray level” quantities, as well.

### SAMPLE PREPARATION AND TESTS RESULTS WITH INCORPORATING TONER EXAMPLES

The choice for selecting the dispersion polymer for masterbatch was found to be very critical to the final toner properties. If the dispersing polymer was too high a viscosity, then good dispersion was not obtained and further, the melt viscosity of the resulting toner was also too high to be useful. Very satisfactory results were obtained when the dispersing polymer had the number average molecular weight of less than 10,000. When the dispersing polymer had acid value in excess of 2.0, then further improvement in the dispersion of the inorganic filler was observed.

A masterbatch was first prepared using a 2-roll mill using Bayoxide Z VP titanium dioxide sold by Bayer Chemicals and a low molecular weight (number average molecular weight of 3,640) polyester polymer ALMACRYL T-500 with an acid value of 18 and Tg of 51C, commercially available from Image Polymers. Concentration of the inorganic filler was kept at 50 percent by weight of this masterbatch. The temperature of the rolls was maintained at 120° C. and the mixture was melt compounded for 15 minutes. Resulting mixture was cooled and granulated, so as to be used as an ingredient to the toner formulation, which was prepared using this masterbatch.

All toner ingredients were first dry powder blended in a 40 liter Henschel mixer for 60 seconds at 1000 RPM to produce a homogeneous blend. A bisphenol-A based polyester (molecular weight 5,500, Tg of 53C) from Reichhold Chemicals Company, commercially available as ATLAC 382 ES, was used as the toner binder polymer and was mixed with 2 pph of Orient Chemicals BONTRON E-84 charge agent. The inorganic filler was also added to the toner mixture in the range of 10 to 25 percent by weight of the total mixture. Aside from the control toner, which did not use the opaque inorganic filler previously prepared as a masterbatch, all other opaque toner formulations contained the masterbatch form of the inorganic filler prepared previously.

The powder blend was then melt compounded in a twin screw co-rotating extruder to melt the polymer binder and disperse the pigments, charge agents, and waxes. Melt compounding was done at a temperature of 230° F. (110° C.) at the extruder inlet, 230° F. (110° C.) increasing to 385° F. (196° C.) in the extruder compounding zones, and 385° F. (196° C.) at the extruder die outlet. The processing conditions were a powder blend feed rate of 10 kg/hr and an extruder screw speed of 490 RPM. The cooled extrudate was then chopped to approximately ⅛ inch size granules.

After melt compounding, the granules were then fine ground in an air jet mill to the desired particle size of about 8 microns. The toner particle size distribution was measured with a Coulter Counter Multisizer and the medium volume weighted diameter was reported. The fine ground toner was then classified in a centrifugal air classifier to remove very small toner particles and toner fines that were not desired in the finished toner. After classification to remove fine particles, the toner had a fineness ratio, expressed as the ratio of the diameter at the 50% percentile to the 16% percentile of the cumulative particle number versus particle diameter, of 1.30 to 1.35.

The resulting mixture was pulverized to yield toner particles of sizes about 8 microns median volume weighted average diameter. The term “particle size” used herein, or the term “size” or “sized” as employed herein in reference to the term “particles,” means the median volume weighted diameter as measured by conventional diameter measuring devices, such as a Coulter Multisizer, sold by Coulter, Inc. of Hialeah, Fla. Median volume weighted diameter is the diameter of an equivalent weight spherical particle which represents the median for a sample.

The classified toner was then surface treated with fumed silica. A hydrophobic silica, designated R972 and manufactured by Nippon Aerosil, was used. Subsequently, 2000 grams of toner were mixed with various amounts (grams) of each component to give a product containing different weight percent of each nanoparticle. The toner and silica were mixed in a 10 liter Henschel mixer with a 4 element impeller for 2 minutes at 2000 RPM. The silica surface treated toner was sieved through a 230 mesh vibratory sieve to remove un-dispersed silica agglomerates and any toner flakes that may have formed during the surface treatment process.

These toners are identified in Table I, along with the additives used in the opaque toner formulations.

The melt rheological behavior of the opaque toner is influenced by amount of inorganic filler used as well as its dispersion quality. Further, the masterbatch preparation prevents the melt viscosity being too high. The desired rheological behavior for a toner melt is determined by the type of fusing sub-system geometry, type of materials selected for the fuser member surface, and the fusing speed. The rheological behavior of the opaque toners formulations in the molten state can be determined by using a dynamic mechanical rheometer such as RDA 700 manufactured by Rheometrics Inc. The complex melt viscosity (eta*) was measured at 120° C. and 1 rad/sec frequency while using 25 mm parallel plates with a gap of 2.0 mm. The melt viscosity results are summarized in Table I for the various opaque toners prepared for optimizing the toner formulation.

TABLE I

| | Wt percent of | | Melt Viscosity |
|---|---|---|---|
| Sample | inorganic filler | Masterbatch | (kpoise) |
| 1 | 0 | | 4.9 |
| 2 | 5 | No | 5.2 |
| 3 | 10 | No | 8.9 |
| 4 | 15 | No | 16.0 |
| 5 | 20 | No | 35.0 |
| 6 | 5 | Yes | 4.9 |
| 7 | 10 | Yes | 5.8 |
| 8 | 15 | Yes | 7.5 |
| 9 | 20 | Yes | 9.8 |

The results indicate that when the masterbatches were prepared first, the resulting melt viscosity of the opaque toner was prevented from being too high. It was found that when the viscosity of the opaque toner was more than a factor of 2 greater than the viscosity of the color toner particles, then differences in the image gloss were easily observed. By employing predispersed inorganic fillers with a refractive index of greater than 1.75 in the preparation of opaque toner, the unwanted increase in the melt viscosity is prevented.

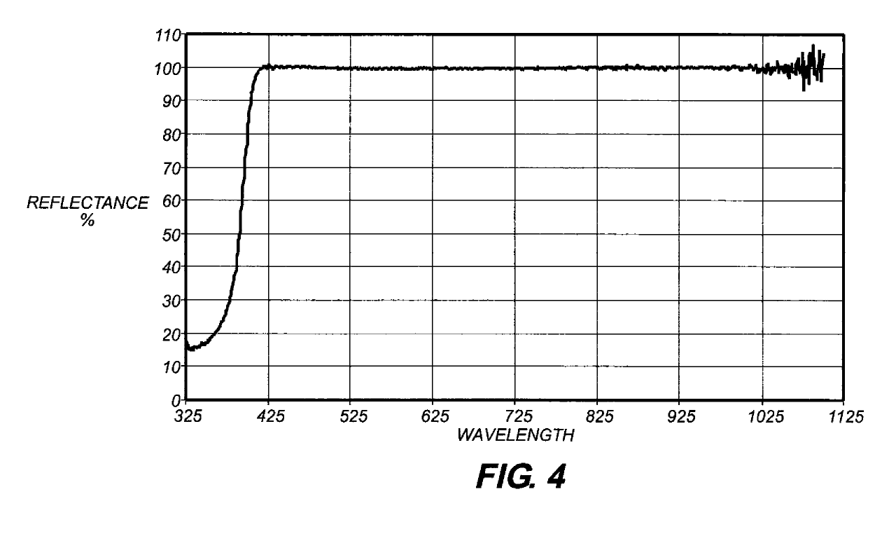

When predispersed forms of inorganic fillers are used, the necessary opacity is reached at a much lower concentration of the inorganic filler. The reflective properties were measured on these opaque toners and in FIG. 4, results of an opaque toner with only 15 percent by weight of inorganic filler as shown. Even at this loading of the inorganic filler, the necessary opacity has been achieved without affecting the toner viscosity significantly. The charging properties of all opaque toners were found to be satisfactory. Developers were further tested in a NEXPRESS 3000 printer and various images were prepared with opaque toner. Satisfactory performance was obtained with these opaque toners as indicated by the process control parameters used for required printing. Color images were produced on both clear transparent film as well as highly colored substrates. The color saturation achieved when opaque toner was present behind the color toners was very evident and prints were perceived to be of high image quality.

The invention has been described in detail with particular reference to certain preferred embodiments thereof, but it will be understood that variations and modifications can be effected within the spirit and scope of the invention.

1. An opaque toner for digital printing wherein an opaque layer can be printed by electrographic techniques, comprising a toner binder, a dispersing polymer, and an inorganic filler with a refractive index of greater than 1.75, wherein the dispersing polymer is compatible with the toner binder and the inorganic filler is predispersed in the dispersing polymer prior to incorporation of the dispersing polymer and inorganic filler into the toner binder.

2. The toner according to claim 1, which further contains a charge agent in the amount of 0.1 to 5 percent by weight of the toner weight.

3. The toner according to claim 1, wherein the dispersing polymer for the inorganic filler has a number average molecular weight of less than 10,000.

4. The toner according to claim 1, wherein the dispersing polymer for the inorganic filler has weight average molecular weight of less than that for the toner binder.

5. The toner according to claim 1, wherein the dispersing polymer for the inorganic filler has an acid value of greater than 2.0.

6. The toner according to claim 1, wherein the inorganic filler comprises titanium dioxide.

7. The toner according to claim 1, wherein the toner further comprise hydrophobic particles of silica and/or titania.

8. The toner according to claim 1, wherein the toner further comprises a wax-based release additive.

9. The toner according to claim 1, wherein the amount of inorganic filler present is between 5 and 25 percent by weight of the toner.

10. An electrographic developer comprising the toner of claim 1 and carrier particles.

11. The developer according to claim 10, wherein the carrier particles comprise magnetic particles.

12. The developer according to claim 10, wherein the toner comprises a developer charge between −30 and −60 microcoulombs/gram.

13. A electrographic print comprising an image formed from one or more marking toners and an opaque toner, wherein the opaque toner comprising a toner binder, a dispersing polymer, and an inorganic filler with a refractive index of greater than 1.75 in an amount between 5 and 25 percent by weight of the opaque toner, wherein the dispersing polymer is compatible with the toner binder and the inorganic filler is predispersed in the dispersing polymer prior to incorporation of the dispersing polymer and inorganic filler into the toner binder of the opaque toner.

14. The print according to claim 13, wherein the opaque toner has a melt viscosity no greater than a factor of 2 as compared with the marking toners.

15. The print according to claim 13, said print comprising a substantially transparent substrate.

16. The print according to claim 15, said print comprising the opaque toner over the marking toner, in areas of the print where opacity or a reflective layer is desired behind the marking toner when viewed through the transparent substrate.

17. The print according to claim 13, said print comprising a highly colored substrate.

18. The print according to claim 13, said print capable of reflecting more than 70% of the incident light in the visible spectrum.

19. A process for electrographic printing of an image on a receiver member, comprising the steps of electrographically forming a desired print image on a receiver member utilizing one or more marking toners and an opaque toner, wherein the opaque toner comprises a toner binder, a dispersing polymer, and an inorganic filler with a refractive index of greater than 1.75 in an amount between 5 and 25 percent by weight of the opaque toner, wherein the dispersing polymer is compatible with the toner binder and the inorganic filler is predispersed in the dispersing polymer prior to incorporation of the dispersing polymer and inorganic filler into the toner binder of the opaque toner; and fixing the opaque toner in an area of the formed print image where an opaque layer is desired.

20. The process according to claim 19 wherein the step of electrographically forming a desired print image utilizes cyan, magenta, yellow, and black colored marking toners, and the amount of opaque toner utilized is at least 40 percent of the maximum laydown possible for each of the colored marking toners.
